(19) United States
(12) Patent Application Publication
(10) Pub. No.: US 2025/0293374 A1
(43) Pub. Date: Sep. 18, 2025

(54) Smart universal compatible composable batteries and system, for any battery operated home or industry electric devices, electric vehicles, electric drones, electric airplanes, electric boats and any other battery operated electric apparatus, with smart connectors.

(71) Applicant: Navtej Singh Dhillon, Supply, NC (US)

(72) Inventor: Navtej Singh Dhillon, Supply, NC (US)

(21) Appl. No.: 19/079,407

(22) Filed: Mar. 13, 2025

Related U.S. Application Data
(60) Provisional application No. 63/564,934, filed on Mar. 13, 2024.

(51) Int. Cl. H01M 50/258; H01M 50/242; H01M 50/507

(52) U.S. Cl. CPC H01M 50/258; H01M 50/242; H01M 50/507

(57) ABSTRACT

Intend to invent and create a new smart universal compatible composable batteries and system, for any battery operated home or industry electric devices, electric vehicles, electric drones, electric airplanes, electric boats and any other battery operated electric apparatus. These batteries are made up of smaller composable batteries units combining up to make up bigger batteries with wide range of capacity, voltage, ampere, ampere hour rating, ranges as specified in the specifications. Further these composable batteries have smart connectors making them compatible with connectors of almost any manufacturer or kind which adhere to specifications.

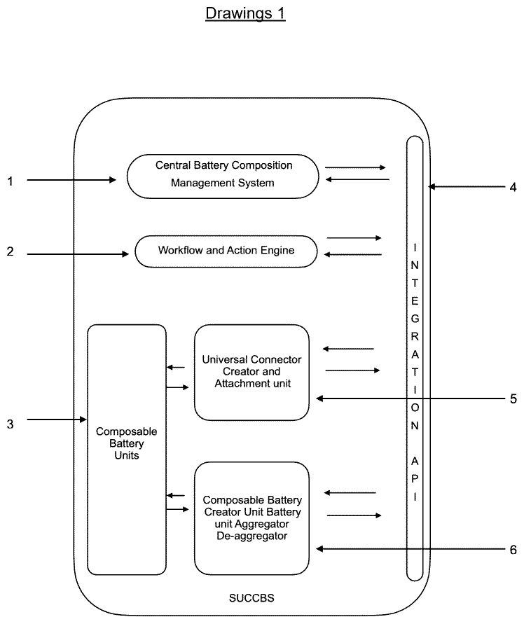

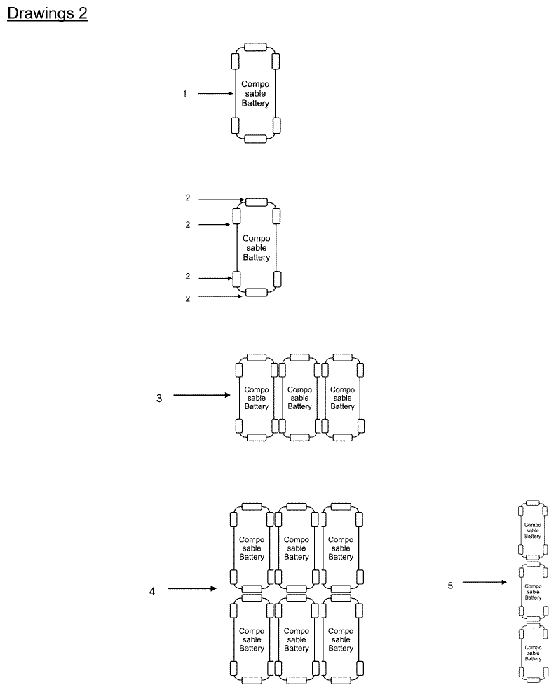

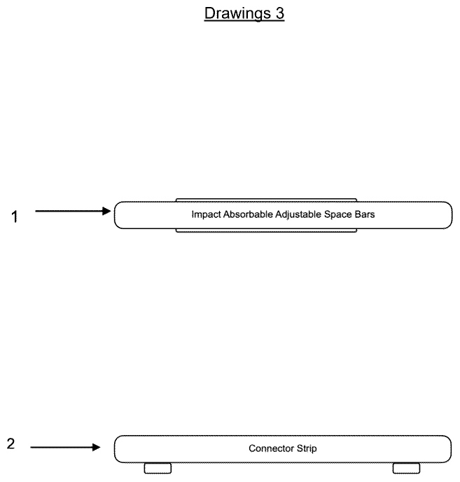

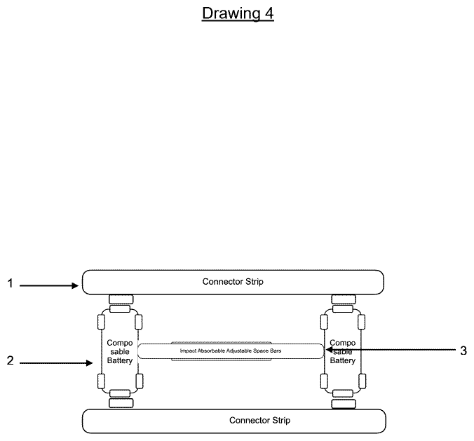

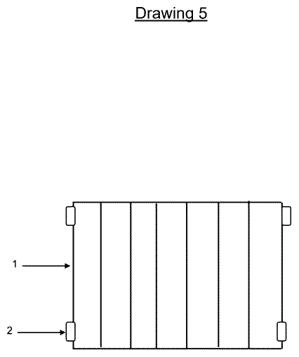

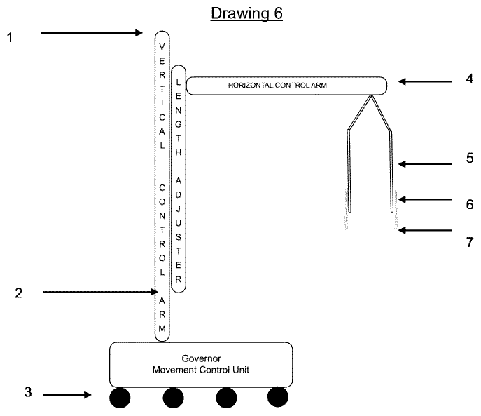

### CROSS-REFERENCE TO RELATED APPLICATIONS

63/564,934|Provisional—: Smart universal compatible composable batteries for any battery operated, home or industry devices, vehicles, drones, airplanes, and any other battery operated apparatus, with smart connectors making them compatible with connectors of any manufacturer or kind.

### STATEMENT REGARDING FEDERALLY SPONSORED RESEARCH OR DEVELOPMENT (IF APPLICABLE)

No, None

### BACKGROUND OF THE INVENTION

The invention is creating, smart universal compatible composable batteries for any battery operated home or industry electric devices, electric vehicles, electric drones, electric airplanes, electric boats and any other battery operated electric apparatus, which are made up smaller batteries units combining up to make up bigger batteries with wide range of capacity, ampere, voltage, ampere hour rating as described in specifications.

Currently wide variety of batteries are available, and as more and more battery operated electric devices are being created, the number of different kind and makes of these batteries is increasing and is going to increase tremendously. With all these different kind and types, there is a potential significant wastage of battery material, and some of the batteries are not used to the full. Further, interoperability of one battery from one electric device or electric apparatus or manufacturer to another is going to become difficult.

As newer electric use cases, and device for the same are introduced, there is going to be electric devices or electric gadgets that will rarely need to use the battery attached while other might use the battery attached more readily. There are going to be use cases where more than two gadgets will complete a job, but only one might need the battery at a time, in those scenarios, only one battery is being used at a time, though there are multiple devices or gadget involved, in that case there needs to be a way to pass on the battery also, along with the job, for the best use of battery.

Newer ways needs to be found where the same batteries can be combined or disjoined to service all the electric gadgets or electric devices or electric automobiles of different kinds and makes.

With the increase in the batteries around the world, the need for battery “material” is going to increase and better way need to be found where the battery “material” is used to its max.

As newer service models, are developed there is going to be a need on how, a service, say a battery service “battery stores”, should be able to address this heterogeneous make up of batteries. Where these batteries of different kinds, capacities, shapes, voltages ratings etc. can be used to the full.

### BRIEF SUMMARY OF THE INVENTION

Intend to invent and create, a new smart universal compatible composable batteries and system, for any battery operated home or industry electric devices, electric vehicles, electric drones, electric airplanes, electric boats and any other battery operated electric apparatus. These batteries are made up of smaller composable batteries units combining up to make up bigger batteries with wide range of capacity, voltage, ampere, ampere hour rating, ranges as specified in the specifications. Further these composable batteries have smart connectors making them compatible with connectors of almost any manufacturer or kind which adhere to specifications. The uniqueness is also in the fact that these composable batteries can be readily combined at the minutes notice.

This invention tries to address some of the problems outlined in the section above and tries to address the best optimal use of the battery “material”, and by addressing the composition of the batteries and the compatibility of them.

Using the invention as described in the description, as the batteries is be made up of smaller, battery units and it is possible to aggregate or dis-aggregate, making it possible, that one given set of smaller units, combined or disjoined, can be used by any electric gadget or electric device or electric automobile or electric drone etc.

As currently wide variety of batteries are available, and as more and more battery operated electric devices are being created, the number of different kind and makes of these batteries is increasing and is going to increase tremendously. With all these different kind and types, there is a potential significant wastage of battery material, and some of the batteries are not used to the full. Further, interoperability of one battery from one electric device or electric apparatus or manufacturer to another is going to become difficult. With this invention as such all these shortcoming will be solved, as the batteries will be made up of smaller composable units and they can be combined to mater larger batteries which work with different devices. Further with universal compatible with smart connectors they connect with heterogeneous connectors, and in the process not waste the battery material.

As newer electric use cases, and device for the same are introduced, there is going to be electric devices or electric gadgets that will rarely need to use the battery attached while other might use the battery attached more readily. There are going to be use cases where more than two gadgets will complete a job, but only one might need the battery at a time, in those scenarios, only one battery is being used at a time, though there are multiple devices or gadget involved, in that case there needs to be a way to pass on the battery also, along with the job, for the best use of battery. With the invention as such such a model is possible

Newer ways needs to be found where the same batteries can be combined or disjoined to service all the electric gadgets or electric devices or electric automobiles of different kinds and makes. With the universal compatible and composable batteries it is be possible to combine or disjoin the batteries to solve the problems mentioned above.

With the increase in the batteries around the world, the need for battery “material” is going to increase and better way need to be found where the battery “material” is used to its max. With the invention as such it is possible to use the same battery for multiple devices or jobs, hence leading to usage of the battery material to the max.

As newer service models, are developed there is going to be a need on how, a service, say a battery service “battery stores”, should be able to address this heterogeneous make up of batteries. Where these batteries of different kinds, capacities, shapes, voltages ratings etc. can be used to the full. This invention is going to act as a basis for creating afore said “battery stores” or service models, were composable batteries can be used to service different kind of electric devices, vehicles.

### BRIEF DESCRIPTION OF THE SEVERAL VIEWS OF THE DRAWING

Drawing 1: Smart universal compatible composable batteries system logical diagram.

Drawing 1: Smart universal compatible composable batteries system logical diagram, Further as depicted in section D.1
1 “Central Battery Composition Management System” comprises of computer logic and system programming, for the complete system and provides the complete overview of the system. It holds the information of the all the composable batteries and all the configuration possible. It holds the information of all the assemblers and there working using sub modules. Further all the assemblers interact with the the system and sub system to create the required batteries. It also holds the inventory of all the composable batteries, connector types and different parts at each location and for each battery creator (assembler, de-assembler). It is the central logical unit to which the individual aggregators, and battery assemblers connect to. Further it comprises of different sub parts as described below. Further as depicted in section D.1
2 “Workflow and Action Engine”, the workflow and action engine holds the workflow of assembly to create a particular battery comprising of composable batteries, it also holds the sets as actions which needs to be performed by the assembler to create the battery for a given configuration, dimension, voltage, ampere, ampere hour. Based on the ratings exacts sets are sent to the aggregator, de-aggregator to pick, assemble the required parts and create the battery. Further as depicted in section D.1
3 is “Universal Connector Creator and Attachment unit, the system relies on “Trade Secret, Smart Connector Technology 1”, “Trade Secret Connector Technology 2”, “Smart physical modifiable connectors”. These connectors are 3D printed using the a 3D printer as based on the configuration used from the composition management system. Further as depicted in section D.4,5
4 is “Composable Battery Creator Unit Battery unit Aggregator De-aggregator”, this is the central piece of the system. And using the API it get the instructions from the center system to carry out it operations. Typically it goes through a series of steps, to get the different parts required, and assemble them using the workflow and actions as sent from the central system to create the final battery from the composable batteries. Further as described in section D3.
5 is “Composable Battery Units”, these are the composable battery units which can be combined to create batteries of any capacity, ampere, voltage and voltage hour, further as described in Drawing 2 and section D2.
6 is “Integration API” is the central API which all the systems use to interact with one another, further all the individual sub systems do expose APIs about their stats and working.

Drawing 2: Composable batteries and composable batteries shown in different configurations.

Drawing 2: Composable batteries and composable batteries shown in different configurations. Further as described in D.2.
1 is “Composable Battery Unit” a single composable battery, which can be any existing secondary (re chargeable) battery technology, with unique connectors. Different connectors are used and placed at horizontal or vertical positions as shown to be able to connect the connectors of other battery units. The composable batteries can be from 10 nm to 100 m. Further described in section D.2
2 “Composable Battery Unit Connectors”, show the different connectors placed at horizontal or vertical positions as shown to be able to connect the connectors of other battery units. Further as described in D.4, 5, 6.
3 “Multiple Composable Battery Units”, shows multiple compostable battery units using vertical connectors.
4 “Composable Battery Units Grid”, shows multiple compostable battery units in grid.
5 “Multiple Composable Battery Units”, shows multiple compostable battery units using horizontal connectors.

Drawing 3: Impact absorbable adjustable space bar and connector strips.

Drawing 3: Impact absorbable adjustable space bar and connector strips.
1 “Impact absorbable adjustable space bar” is the unique bar which is used to hold individual composable batteries and is used to create a the required dimensions of the battery. The space bar has a collapsable bar which can absorb energy in case of an impact, reducing the risk of damage to the battery units. The bar has rolling screw mechanism to adjust the length of the bar. Further the space has advanced “Trade Secret” heat sink and collection impacted technology.
2 “Connector Strip” is used to join individual compostable batteries in case of co-joining of individual battery units is not possible. The connector strip has advanced “Trade Secret” heat sink technology which can reduce the heating of the batteries. Further the connector strip uses the “Trade Secret, Smart Connector Technology 1”, “Trade Secret Connector Technology 2”, and “Trade Secret, Smart Heat Dispenser Technology 1”.

Drawing 4: Example composable batteries configuration with connector strips and impact absorbable adjustable space bar.

Drawing 4: Is a example of composable batteries configuration with connector strips and Impact absorbable adjustable space bar.
1: “Connector Strip” is the connector strip which is connected to the composable batteries.
2: “Composable Battery Units”, is the composable battery units.
3: “Impact absorbable adjustable space bar”, is the space bar which is holding the compostable battery units and making the design steady, and achieving the required dimensions of battery.

Drawing 5: Example container chamber for holding composable batteries.

Drawing 5: Example container chamber for holding composable batteries.
1: “Container chamber”, is the container which holds the individual composable batteries, or composable batteries with connector strips, impact absorbable adjustable space bar.
2: “Smart Connectors”, are the smart connectors, further as described in D.4, 5, 6.

Drawing 6: Composable batteries aggregator, de-aggregator, and battery assembler.

Drawing 6: Is composable batteries aggregator, de-aggregator, and battery assembler.
1: “Vertical Control Arm”, is the vertical control arm which moves the assembly up and down, and on its axis. It uses the technology that exists as of today for similar vertical movement arms, using hydraulics, and line wires.
2: “Length Adjuster”, is the vertical control arm extension which can further adjust the length and increase the vertical reach.
3: “Governor Movement Control Unit”, is the central logical unit of the sub system, along with the governor logic to control the movement of the arms, object fork to hold the parts of the system and move them or hold them at a certain place, while adjustable and sliding tightening mechanism and connector and cattery change unit, can change put the required object at the place and assemble it.
4: “Horizontal Control Arm”, is the horizontal control arm which can move the assembly to and fro horizontally.
5: “Object Fork”, control fork which move, hold, place, objects, composable batteries, space bars, connectors.
6: “Adjustable and sliding tightening mechanism”, is mechanism comprising of adjustable screws for tightening, it can operate while the “object fork” holds an object a certain position.
7: “Connector and Battery change unit”, is the control mechanism which can change a connector or battery unit.

### DESCRIPTION

### DETAILED DESCRIPTION OF THE INVENTION

Intend to invent and create, a new smart universal compatible composable batteries and system, for any battery operated home or industry electric devices, electric vehicles, electric drones, electric airplanes, electric boats and any other battery operated electric apparatus. These batteries are made up of smaller composable batteries units combining up to make up bigger batteries with wide range of capacity, voltage, ampere, ampere hour rating, ranges as specified in the specifications. Further these composable batteries have smart connectors making them compatible with connectors of almost any manufacturer or kind which adhere to specifications. The uniqueness is also in the fact that these composable batteries can be readily combined at the minutes notice.

This invention tries to address some of the problems outlined in the section above and tries to address the best optimal use of the battery “material”, and by addressing the composition of the batteries and the compatibility of them.

Using the invention as described in the description, as the batteries is be made up of smaller, battery units and it is possible to aggregate or dis-aggregate the smaller composable battery units, making it possible, that one given set of smaller units, combined or disjoined, can be used by any electric gadget or electric device or electric automobile or electric drone etc.

As currently wide variety of batteries are available, and as more and more battery operated electric devices are being created, the number of different kind and makes of these batteries is increasing and is going to increase tremendously. With all these different kind and types, there is a potential significant wastage of battery material, and some of the batteries are not used to the full. Further, interoperability of one battery from one electric device or electric apparatus or manufacturer to another is going to become difficult. With this invention as such all these shortcoming will be solved, as the batteries will be made up of smaller composable units and they can be combined to larger batteries which work with different devices. Further with universal compatible with smart connectors they connect with heterogeneous connectors, and in the process not waste the battery material.

As newer battery driven electric use cases, and device for the same are introduced, there is going to be electric devices or electric gadgets that will rarely need to use the battery attached while other might use the battery attached more readily. There are going to be use cases where more than two gadgets will complete a job, but only one might need the battery at a time, in those scenarios, only one battery is being used at a time, though there are multiple devices or gadget involved, in that case there needs to be a way to pass on the battery also, along with the job, for the best use of battery. With the invention such a model is possible.

Newer ways needs to be found where the same batteries can be combined or disjoined to service all the electric gadgets or electric devices or electric automobiles of different kinds and makes. With the universal compatible and composable batteries it is be possible to combine or disjoin the batteries to solve the problems mentioned above.

With the increase in the batteries around the world, the need for battery “material” is going to increase and better way need to be found where the battery “material” is used to its max. With the invention as such it is possible to use the same battery for multiple devices or jobs, hence leading to usage of the battery material to the max.

As newer service models, are developed there is going to be a need on how, a service, say a battery service “battery stores”, should be able to address this heterogeneous make up of batteries. Where these batteries of different kinds, capacities, shapes, voltages ratings etc. can be used to the full. This invention is going to act as a basis for creating afore said “battery stores” or service models, were composable batteries can be used to service different kind of electric devices, vehicles.

Smart universal compatible composable batteries and system (SUCCBS) for any battery operated home or industry electric devices, electric vehicles, electric drones, electric airplanes, electric boats and any other battery operated electric apparatus, the system is made up of composable batteries units (CBU)s, which can be attached or detached to make up battery of wide range of capacity, voltage, ampere, ampere hour rating. CBUs (Composable batteries units) are of varying shapes and sizes, and be able to aggregate or de-aggregated these battery units using the CBAODWCAVSUD (composable battery aggregator or de-aggregator, with capacity and voltage step up or step down), creating batteries of wide range of capacity, ampere, ampere hour and voltage ratings. Further SUCCBS, utilizes induction based connectors, “Trade Secret, Smart Connector Technology 1”, “Trade Secret Connector Technology 2”, “Trade Secret, Smart Heat Dispenser Technology 1” and use smart physical modifiable connectors to physical modify the connectors, to couple with most of electric devices, vehicles.

Battery Size range: The system can create batteries ranging from 100 nm (nano meters) to 5000 m (meters). Further using the composable battery technology as referred in other patent can create composable batteries in that range.

Voltage, Amperes and Ampere hours ranges: The system can creates batteries ranging from 0.1 V to 44,000 V, and from 0.1 Amperes to 1,000,000 Amperes. Further system can create batteries from 1 AH to 1,000,000 AH.

Intend to invent and create, SUCCBS will use CBAODWCAVSUD (composable battery aggregator or de-aggregator, with capacity and voltage step up or step down) to aggregate or de-aggregate CBs to make batteries of any shape, size, capacity or voltage rating.

As the goal of the system is to achieve highest Interoperability, the libraries of the system is implemented in multiple programming languages. The first implementation being in java, c#, objective c. The interfaces written in cross platform frameworks, with mobile responsive and AR/VR convertible. For all the functionality for all the modules are developed with SOA (service oriented architecture) with the API first approach with public, protected and private interfaces, these interfaces further makes the system very highly interoperable. Giving the system to simultaneously hosted on prem, data centers, and its own public cloud, for the UI interfaces, broker and managing of the battery management systems and system as such. The system uses other existing frameworks for mobile, tablet and AR/VR. The system also uses mysql, Postgres, file system along with very secure hash safe custom native persistent data structures, and data lake. Also as the system is implemented as SAAS in multi region, communication between its different multi region SAAS, across different geographies and countries.

### Glossary:

SUCCBS: Smart universal compatible composable batteries and system (SUCCBS).
CBU: Composable batteries units
CBAODWCAVSUD: composable battery aggregator or de-aggregator, with capacity, voltage, ampere, ampere hour, step up or step down.
IDBPC: Induction based physical connectors.
SPMC: Smart physical modifiable connectors.

### Detailed Description and Working of SUCCBS

Smart universal compatible composable batteries and system (SUCCBS) for any battery operated home or industry electric devices, electric vehicles, electric drones, electric airplanes, electric boats and any other battery operated electric apparatus, the system is made up of composable batteries units (CBU)s, which can be attached or detached to make up battery of wide range of capacity, voltage, ampere, ampere hour rating. CBUs (Composable batteries units) are of varying shapes and sizes, and be able to aggregate or de-aggregated these battery units using the CBAODWCAVSUD (composable battery aggregator or de-aggregator, with capacity and voltage step up or step down), creating batteries of wide range of capacity, ampere, ampere hour and voltage ratings. Further SUCCBS, utilizes induction based connectors, “Trade Secret, Smart Connector Technology 1”, “Trade Secret Connector Technology 2”, “Trade Secret, Smart Heat Dispenser Technology 1” and use smart physical modifiable connectors to physical modify the connectors, to couple with most of electric devices, vehicles. Further as described below and in each sub section.

The system works on existing secondary batteries of different kinds, and also on “Trade Secret -Hydrogen Cell Based Compostable Battery Units”.

Drawing 1: Smart universal compatible composable batteries system logical diagram.
1 “Central Battery Composition Management System” comprises of computer logic and system programming, for the complete system and provides the complete overview of the system. It holds the information of the all the composable batteries and all the configuration possible. It holds the information of all the assemblers and there working using sun modules. Further all the assemblers interact with the the system and sub system to create the required batteries. It also holds the inventory of all the composable batteries, connector types and different parts at each location and for each battery creator (assembler, de-assembler). It is the central logical unit to which the individual aggregators, and battery assemblers connect to. Further it comprises of different sub parts as described below. Further as depicted in section D.1
2 “Workflow and Action Engine”, the workflow and action engine holds the workflow of assembly to create a particular battery comprising of composable batteries, it also holds the sets as actions which needs to be performed by the assembler to create the battery for a given configuration, dimension, voltage, ampere, ampere hour. Based on the ratings exacts sets are sent to the aggregator, de-aggregator to pick, assemble the required parts and create the battery. Further as depicted in section D.1
3 is “Universal Connector Creator and Attachment unit, the system relies on “Trade Secret, Smart Connector Technology 1”, “Trade Secret Connector Technology 2”, “Smart physical modifiable connectors”. These connectors are 3D printed using the a 3D printer as based on the configuration used from the composition management system. Further as depicted in section D.4,5
4 is “Composable Battery Creator Unit Battery unit Aggregator De-aggregator”, this is the central piece of the system. And using the API it get the instructions from the center system to carry out it operations. Typically it goes through a series of steps, to get the different parts required, and assemble them using the workflow and actions as sent from the central system to create the final battery from the composable batteries. Further as described in section D3.
5 is “Composable Battery Units”, these are the composable battery units which can be combined to create batteries of any capacity, ampere, voltage and voltage hour, further as described in Drawing 2 and section D2.

6 is “Integration API” is the central API which all the systems use to interact with one another, further all the individual sub systems do expose APIs about their stats and working.

Battery Size range: The system can create batteries ranging from 100 nm (nano meters) to 5000 m (meters). Further using the composable battery technology as referred in other patent can create composable batteries in that range.

Voltage, Amperes and Ampere hours ranges: The system can creates batteries ranging from 0.1 V to 44,000 V, and from 0.1 Amperes to 1,000,000 Amperes. Further system can create batteries from 1 AH to 1,000,000 AH.

Though the system calls for using the automatic way to assemble or de-assemble, batteries but for smaller composable batteries, can be assemble or de-assembled using the bare hands also.

### Detailed Description and Working of CBU

At the heart of this invention is composable battery units. The composable battery units, can be any existing battery technology as it is known today, its the unique placement and unique trade secret connectors, which are able to join there composable battery units, and create bigger batteries. Further these is one trade secret composable battery type, “Trade Secret-Hydrogen Cell Based Compostable Battery Units”. The connectors are very very efficient and make the compressibility to work. With the unique trade secret connector technology, the these connectors can adjust to the connectors of any make and model, making if universal connector. Further with very composable nature of the batteries and able to connect individual units, in different layouts and grids, using the battery aggregator, de-aggregator, it is possible to create the battery of wide range of capacity, dimensions, voltage, amperes, and ammeter hours.

Composable battery unit size range: The battery units are from 100 nm (nano meters) to 100 m (meters). Further using the composable battery technology as referred in other patent can create composable batteries in that range.

Voltage, Amperes and Ampere hours ranges: The system can creates batteries ranging from 0.1 V to 11,000 V, and from 0.1 Amperes to 10,000 Amperes. Further system can create batteries from 1 AH to 10,000 AH.

The composable batteries are typically secondary batteries and can be of any existing kind, some of the kinds are:
A. Lithium
B. Lithium
C. “Trade Secret-Hydrogen Cell Based Compostable Battery Units”.
D. Organic-compostable battery types
—xxxxxx

Drawing 2: Composable batteries and composable batteries shown in different configurations. Further as described in D.2.
1 is “Composable Battery Unit” a single composable battery, which can be any existing secondary (re chargeable) battery technology, with unique connectors. Different connectors are used and placed at horizontal or vertical positions as shown to be able to connect the connectors of other battery units. The composable batteries can be from 10 nm to 100 m. Further described in section D.2
2 “Composable Battery Unit Connectors”, show the different connectors placed at horizontal or vertical positions as shown to be able to connect the connectors of other battery units. Further as described in D.4, 5, 6.
3 “Multiple Composable Battery Units”, shows multiple compostable battery units using vertical connectors.
4 “Composable Battery Units Grid”, shows multiple compostable battery units in grid.
5 “Multiple Composable Battery Units”, shows multiple compostable battery units using horizontal connectors.

### Detailed Description and Working of CBAODWCAVSUD

This sub system which gets its instructions, workflow, and actions steps from the central system. The system works automatically, and works on composable battery units (secondary batteries). The sub system is able to get the appropriate parts, compostable batteries units of right voltage, amperes, size and type, get the right compatible connectors, space bars, connectors strips, and battery containers, and assemble the battery of appropriate rating as configuration sent from the central system and instructed by the operator. It relies on other sub systems as further described below.

A typical workflow is described below.

I. Get the to be assembled battery from the central system

II. Get the workflow and action from the central system

III. Validate the action against the inventory and checks

IV. Initiate 3D printer to print the container dimensions

V. Select the composable batteries and layout configuration

VI. Select the adjustable impact absorbing space bars

VII. Select connector bars

VIII. Select connectors

IX. Assemble the battery

Drawing 6: Is composable batteries aggregator, de-aggregator, and battery assembler.
1: “Vertical Control Arm”, is the vertical control arm which moves the assembly up and down, and on its axis. It uses the technology that exists as of today for similar vertical movement arms, using hydraulics, and line wires.
2: “Length Adjuster”, is the vertical control arm extension which can further adjust the length and increase the vertical reach.
3: “Governor Movement Control Unit”, is the central logical unit of the sub system, along with the governor logic to control the movement of the arms, object fork to hold the parts of the system and move them or hold them at a certain place, while adjustable and sliding tightening mechanism and connector and cattery change unit, can change put the required object at the place and assemble it.
4: “Horizontal Control Arm”, is the horizontal control arm which can move the assembly to and from horizontally.
5: “Object Fork”, control fork which move, hold, place, objects, composable batteries, space bars, connectors.
6: “Adjustable and sliding tightening mechanism”, is mechanism comprising of adjustable screws for tightening, it can operate while the “object fork” holds an object a certain position.
7: “Connector and Battery change unit”, is the control mechanism which can change a connector or battery unit.

### Detailed description and working “Trade Secret, Smart Connector Technology 1”, “Trade Secret Connector Technology 2”

Trade secret name “Smart Connector Technology 1”, which is suitable for very high voltage, very high amp or very high capacity ratings, and with this unique technology, the connectors do not heat at all, with no observable losses, and operate as if its just one continuous connector of one metal.

Trade secret name “Smart Connector Technology 2”, which is suitable for low to medium voltage, low to medium amp or low to medium capacity ratings, and with this unique technology, the connectors have very minimum or to no heat losses, and very little to no observable losses.

Further the system unique high performance induction based connectors and smart physical modifiable connectors.

### Detailed Description and Working “Trade Secret, Smart Heat Dispenser Technology 1”

Trade secret name “Smart Heat Dispenser Technology”, with the unique and innovative, smart “Smart Heat Dispenser Technology 1” (trade secret), the technology as such is able to further reduce the heat loses and, also is critical piece in keeping the heating of battery at sub operation temperatures with gradual heat dissipation technology. The technology as such can make even batteries which have heating problems to work in sub operational temperatures.

### Detailed Description with Architectural Diagrams and Drawings, Working of Different Sub Systems, Systems and Interactions Between Them

As the goal of the system is to achieve highest Interoperability, the libraries of the system is implemented in multiple programming languages. java, c#, objective c. The interfaces written in cross platform frameworks, with mobile responsive. There are two modes of invoking the system, one being the API interface of “Plug and Play” interface of the system, the other being implementation is the native implementation, where the libraries, firmwares are created, and embedded in the device OS and OEM. For all the functionality for all the modules are developed with SOA (service oriented architecture) with the API first approach with public, protected and private interfaces, these interfaces further makes the system very highly interoperable. Giving the system to simultaneously hosted on prem, data centers, and its own public cloud, for the UI interfaces, broker and managing of the battery management systems and system as such. The system also uses mysql, Postgres, file system along with very secure hash safe custom native persistent data structures, and data lake. Also as the system is implemented as SAAS in multi region, communication between its different multi region SAAS, across different geographies and countries.

1. Claim to invent and create, smart universal compatible composable batteries and system (SUCCBS) for any battery operated home or industry electric devices, electric vehicles, electric drones, electric airplanes, electric boats and any other battery operated electric apparatus, the system is made up of composable batteries units (CBU) s, which can be attached or detached to make up battery of wide range of capacity, voltage, ampere, ampere hour rating.

2. Claim to invent and create, (composable batteries units) CBUs of varying shapes and sizes, and be able to aggregate or de-aggregated these battery units using the CBAODWCAVSUD (composable battery aggregator or de-aggregator, with capacity and voltage step up or step down), creating batteries of wide range of capacity, ampere, ampere hour and voltage ratings.

3. Claim to invent and create, that SUCCBS, utilizes induction based connectors, “Trade Secret, Smart Connector Technology 1”, “Trade Secret Connector Technology 2”, “Trade Secret, Smart Heat Dispenser Technology 1” and use smart physical modifiable connectors to physical modify the connectors, to couple with most of electric devices, vehicles.
